(19) United States
(12) Patent Application Publication
(10) Pub. No.: US 2009/0101817 A1
(43) Pub. Date: Apr. 23, 2009

(54) CHARGED PARTICLE APPLICATION APPARATUS

(76) Inventors: Takashi OHSHIMA, Saitama (JP); Michio Hatano, Tokyo (JP); Hideyuki Nagaishi, Hachioji (JP); Mitsugu Sato, Hitachinaka (JP); Muneyuki Fukuda, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/252,862

(22) Filed: Oct. 16, 2008

(30) Foreign Application Priority Data
Oct. 18, 2007 (JP) 2007-271609

(51) Int. Cl. G01N 23/00

(52) U.S. Cl. 250/310

(57) ABSTRACT

The present invention provides a highly sensitive, thin detector useful for observing low-voltage, high-resolution SEM images, and provides a charged particle beam application apparatus based on such a detector. The charged particle beam application apparatus includes a charged particle irradiation source, a charged particle optics for irradiating a sample with a charged particle beam emitted from the charged particle irradiation source, and an electron detection section for detecting electrons that are secondarily generated from the sample. The electron detection section includes a diode device that is a combination of a phosphor layer, which converts the electrons to an optical signal, and a device for converting the optical signal to electrons and subjecting the electrons to avalanche multiplication, or includes a diode device having an electron absorption region that is composed of at least a wide-gap semiconductor substrate with a bandgap greater than 2 eV.

### CLAIM OF PRIORITY

The present application claims priority from Japanese patent application JP 2007-271609, filed on Oct. 18, 2007, the content of which is hereby incorporated by reference into this application.

### BACKGROUND OF THE INVENTION

The present invention relates to a charged particle application apparatus that contains a scanning electron microscope (SEM) for observing a microstructure with an electron beam.

Conventional scanning electron microscopes (SEMs) mostly use an E-T (Everhart-Thornley) detector for low energy secondary electrons as an electron beam detector for microscope image acquisition. As shown in FIG. 2, the E-T detector causes electrons (e⁻) generated from a sample to collide against a scintillator 20 for the purpose of generating light (hν), allows a light guide 21 to move the generated light (hν) outside a wall 23 of a vacuum device, and permits a photomultiplier 22 to detect the light (hν) and generate a signal current. In FIG. 2, Vp is a voltage source that applies a voltage to the scintillator 20 through a feed-through 24, and Vd is an operating voltage of the photomultiplier 22.

When, for instance, backscattered electrons are to be detected under an objective lens or in other similar situations where spatial limitations exist, an SSD (Solid State Detector) having a silicon PIN photodiode structure is mostly used. This SSD is also called a semiconductor detector. It is of a silicon PIN photodiode structure in which a low impurity concentration layer is formed between p-type and n-type semiconductors of a p-n junction to use a large region as a depletion layer. It detects a current that is generated when an electron beam entering the depletion layer creates electron-hole pairs. The higher the incidence energy E is, the larger the number of electron-hole pairs is generated here. The resulting gain approximates to E/3.6. When, for instance, a sample is irradiated with an electron beam with an acceleration voltage of approximately 10 kV for observation purposes, the maximum backscattered electron energy from the sample is approximately 10 kV. Therefore, a current amplified approximately 2000-fold can be detected in the case of incidence on an SSD. When, on the other hand, a low energy electron beam is used for observation purposes, or more specifically, when 1 kV incident energy is used, the gain expected from an approximation formula is as low as 200 or so. Further, the mean free path for incident electrons within a solid substance such as silicon is extremely short in reality. This decreases the number of electrons that reach the depletion layer. It means that only an extremely small signal can be obtained. Consequently, the SSD having a silicon PIN photodiode structure is not suitable for the detection of low energy backscattered electrons.

As is well known, an avalanche photodiode (APD) having an avalanche multiplication function is applied to the detection system of an electron microscope. Such application is proposed, for instance, in JP-A-09-64398.

The use of an avalanche photodiode for signal amplification is readily conceivable. Such use is proposed, for instance, in JP-A-09-64398 and JP-A-2005-85681. When the avalanche photodiode is optimized for light incidence, it is expected that the gain caused by the avalanche effect is approximately 200. In reality, however, the above use of an avalanche photodiode for signal amplification merely provides a gain of approximately 20. Such an unsatisfactory result is obtained because of crystal defect introduction caused by electron beam incidence or because of electron-hole pair generation in a region irrelevant to light. The proposal in JP-A-2005-85681 basically involves the application of a high voltage as is the case with an E-T scintillator. Therefore, if an attempt is made to use the avalanche photodiode while it is placed under an objective lens, the electron beam of a probe is affected by the high voltage so that the performance of an electron microscope is significantly deteriorated.

Meanwhile, an MCP (Micro-Channel Plate) is used as a device for amplifying even low energy electrons at a high amplification ratio. A thin detector composed of two MCPs is now commercially available and widely used for charged particle measurement. When this detector is to be used as a backscattered electron detector for an SEM, a voltage as high as approximately 1 kV to 2 kV needs to be applied to both end faces of an MCP. A thickness of approximately 5 mm is required for placing the entire detector in a case with a collection electrode mounted on the back side of an MCP. Further, a high voltage is applied to the front surface so that an electric field leaks toward the sample and affects a probe beam if no countermeasure is taken. To avoid this problem, it is necessary to seal the electric field with a mesh or the like. As a result, proximity observation cannot be accomplished while the working distance (WD), that is, the distance between the objective lens and sample surface, is not longer than 15 mm. In low-voltage SEM, resolution is governed by chromatic aberration and diffraction aberration. The best way to reduce the chromatic aberration is to decrease the distance between the objective lens principal plane and sample. Therefore, thick conventional detectors are not adequate for observing low-energy backscattered electrons with high resolution.

Further, it is known, as disclosed in JP-A-2005-260008, that a diamond-based lattice detector can be used to detect, for instance, X-rays and ultraviolet light with the detection sensitivity raised by avalanche multiplication.

### SUMMARY OF THE INVENTION

As described above, the detectors for use in low-voltage SEM are large in size when they are designed to detect low energy electrons with high sensitivity as far as they are based on the conventional technologies. Therefore, such detectors cannot be installed under an objective lens or in a limited space. Further, when a backscattered electron detector based on the conventional technologies is set with the distance between an objective lens and sample increased, the resolution decreases. Furthermore, the detectors based on the conventional technologies are sensitive to light so that their detection function cannot be exercised simultaneously with the measurement function of probe light.

In view of the above circumstances, it is an object of the present invention to provide a highly sensitive, thin electron detector useful for observing, for instance, low-voltage, high-resolution SEM images, and provide a charged particle beam application apparatus based on such an electron detector.

To achieve the above object, there is provided a charged particle beam application apparatus including: a charged particle source; a charged particle optics for irradiating a sample with a charged particle beam emitted from the charged particle source; and an electron detection section for detecting electrons that are secondarily generated from the sample; wherein the electron detection section includes a diode device that is a combination of a phosphor layer, which converts the electrons secondarily generated from the sample to an optical signal, and a device for converting the optical signal to electrons and subjecting the electrons to avalanche multiplication; wherein the phosphor layer uses ZnO, SnO₂, or ZnS as a base material and is mainly made of at least one type of phosphor that emits light when struck by 1 keV or lower energy electrons; and wherein the device for converting the optical signal to electrons and subjecting the electrons to avalanche multiplication is mainly composed of Si.

Alternatively, the electron detection section includes a diode device having an electron absorption region that is composed of at least a wide-gap semiconductor substrate with a bandgap greater than 2 eV, wherein the electron absorption region is configured so that two electrodes are mounted on the substrate and positioned face to face to generate electron-hole pairs upon incidence of electrons secondarily generated from the sample.

Typical configurations of the present invention will now be described.

(1) According to one aspect of the present invention, there is provided a charged particle beam application apparatus including: a charged particle source; a charged particle optics for irradiating a sample with a charged particle beam emitted from the charged particle source; and an electron detection section for detecting electrons that are secondarily generated from the sample; wherein the electron detection section includes a diode device that is a combination of a phosphor layer, which converts the electrons secondarily generated from the sample to an optical signal, and a device for converting the optical signal to electrons and subjecting the electrons to avalanche multiplication; wherein the phosphor layer uses ZnO, SnO₂, or ZnS as a base material and is mainly made of at least one type of phosphor that emits light when struck by 1 keV or lower energy electrons; and wherein the device for converting the optical signal to electrons and subjecting the electrons to avalanche multiplication is mainly composed of Si.

(2) According to another aspect of the present invention, there is provided a charged particle beam application apparatus including: a charged particle source; a charged particle optics for irradiating a sample with a charged particle beam emitted from the charged particle source; and an electron detection section for detecting electrons that are secondarily generated from the sample; wherein the electron detection section includes a diode device having an electron absorption region that is composed of at least a wide-gap semiconductor substrate with a bandgap greater than 2 eV; and wherein the electron absorption region is configured so that two electrodes are mounted on the substrate and positioned face to face to generate electron-hole pairs upon incidence of electrons secondarily generated from the sample.

(3) According to another aspect of the present invention, there is provided the charged particle beam application apparatus as described in (1) above, wherein the phosphor is mainly made of a ZnO:Zn phosphor material or a SnO₂:Eu phosphor material.

(4) According to another aspect of the present invention, there is provided the charged particle beam application apparatus as described in (2) above, wherein the wide-gap semiconductor substrate is made of a GaP, GaN, ZnO, or C single-crystal semiconductor.

(5) According to another aspect of the present invention, there is provided the charged particle beam application apparatus as described in (1) or (2) above, further including a detecting circuit which is positioned near the electron detection section or an electron beam application apparatus to apply a current or voltage for operating the electron detection section and amplify or transmit an electrical signal from the electron detection section.

(6) According to another aspect of the present invention, there is provided the charged particle beam application apparatus as described in (1) or (2) above, wherein the electron detection section is positioned near a path for an electron beam incident on the sample.

(7) According to another aspect of the present invention, there is provided the charged particle beam application apparatus as described in (1) or (2) above, wherein the electron detection section has an opening for the passage of the electron beam and is positioned in a path for the electron beam.

(8) According to another aspect of the present invention, there is provided the charged particle beam application apparatus as described in (1) or (2) above, wherein the electron detection section has a plurality of detection areas and a section for directing electrons generated from the sample to the plurality of detection areas in accordance with energy.

(9) According to another aspect of the present invention, there is provided the charged particle beam application apparatus as described in (4) above, further including a section for irradiating the sample with light, wherein the irradiation light has a longer wavelength than the absorption edge of the wide-gap semiconductor substrate for the electron detection section.

(10) According to still another aspect of the present invention, there is provided the charged particle beam application apparatus as described in (9) above, further including an ion beam column for converging an ion beam emitted from an ion source onto the sample for processing purposes, wherein an electron optics and the ion beam column are positioned in the same vacuum chamber.

The present invention realizes a highly sensitive, thin electron detector useful for observing, for instance, low-voltage, high-resolution SEM images, and provides a charged particle beam application apparatus based on such an electron detector.

### BRIEF DESCRIPTION OF THE DRAWINGS

FIG. 1(a) shows a typical configuration of a charged particle beam application apparatus according to a first embodiment of the present invention. FIG. 1(b) shows an electron detector that is used with the charged particle beam application apparatus. FIG. 1(c) is a structural cross-sectional view of the electron detector.

FIG. 2 illustrates the electron detector.

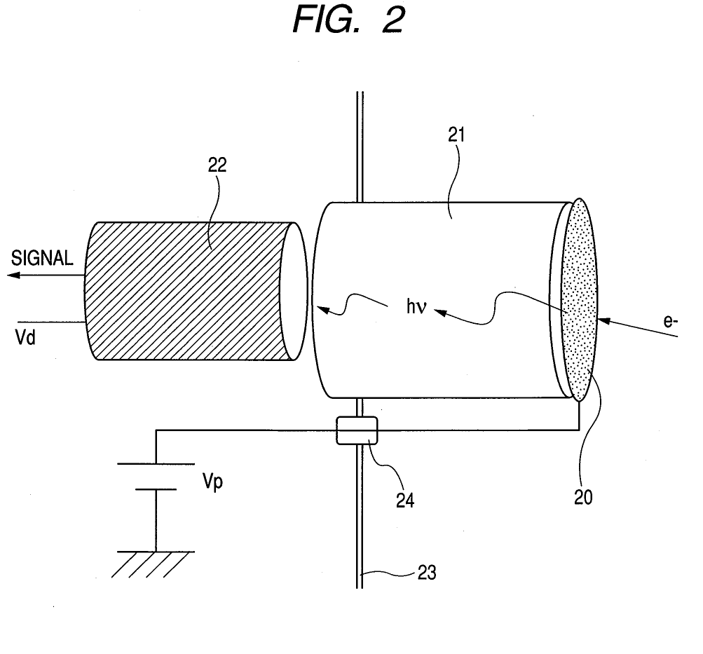

FIG. 3(a) shows the electron detector according to the present invention as viewed from the sample side. FIG. 3(b) is a schematic diagram illustrating an electron detector main body, which is placed in a case.

FIGS. 4(a) to 4(c) illustrate typical detecting circuits for use in the electron detector according to the present invention.

FIGS. 5(a) to 5(d) illustrate some variations of the electron detector according to the present invention.

FIGS. 6(a) to 6(e) show the electron detector according to a second embodiment of the present invention and illustrate the structure and typical fabrication method of the electron detector composed of a substrate having a large energy gap.

FIGS. 7(a) and 7(b) illustrate an example of an amplification circuit for the electron detector according to the second embodiment of the present invention.

FIG. 8 illustrates a cross-sectional structure of the electron detector according to the second embodiment of the present invention.

FIG. 9 illustrates a typical configuration of an electron beam application apparatus according to a third embodiment of the present invention.

FIG. 10 illustrates a typical modification of the third embodiment of the present invention.

FIG. 11 illustrates a typical configuration of the electron beam application apparatus according to a fourth embodiment of the present invention.

FIG. 12 illustrates a typical modification of the fourth embodiment of the present invention.

### DETAILED DESCRIPTION OF THE PREFERRED EMBODIMENTS

Embodiments of the present invention will now be described with reference to the accompanying drawings.

### First Embodiment

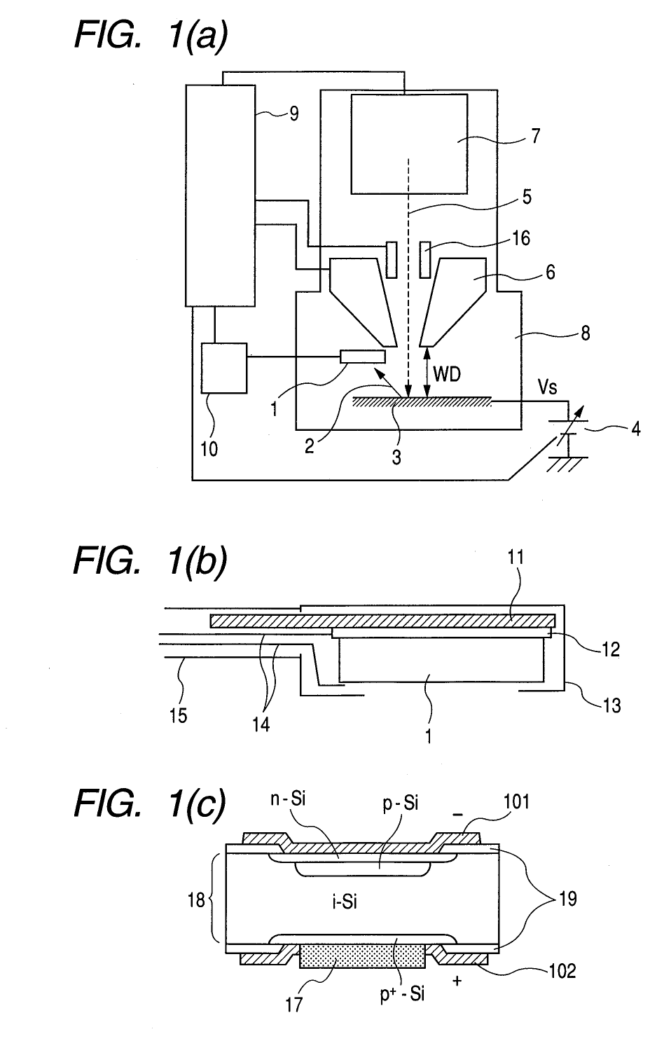

FIGS. 1(a) to 1(c) show a charged particle beam application apparatus according to a first embodiment of the present invention.

The present invention can be applied not only to a scanning electron microscope (SEM) but also to a charged particle beam application apparatus including, for instance, a microscope based on an ion beam.

The description of the present embodiment relates to an electron detector (electron detection section) that is thin and highly sensitive to low energy electrons, and to a case where the electron detector is applied to a scanning electron microscope as an example of the charged particle beam application apparatus.

In a scanning electron microscope, a probe electron beam 5, which is generated from an electron beam irradiation source 7 containing an electron source, is scanned in x-y direction by a deflector 16. Electrons 2, which are secondarily generated from a sample 3, are detected by an electron detector 1, and converted and adjusted to an appropriate voltage signal by a detecting circuit 10, and forwarded to a controller 9. The controller 9 processes an electron detection signal in accordance with a generated scan signal to form a two-dimensional SEM image. The reference numeral 4 in FIG. 1(a) denotes a retarding voltage source, which applies a voltage Vs to the sample 3.

The electron detector 1 is installed near the lower surface of an objective lens 6 or at a position closer to the sample 3. This installation scheme is suitable for detecting a beam of high energy electrons among electrons that are generated from the sample 3 upon incidence of the probe electron beam 5. As shown in FIG. 1(b), the electron detector 1 is fastened to a base plate 11 via an adhesion layer 12 with wires 14 connected to an anode electrode and a cathode electrode, entirely placed inside a case 13, provided with an opening facing toward the sample, and constructed to suppress extraneous noise. As shown in FIG. 1(c), the electron detector 1 includes a phosphor layer 17, which emits light when struck by low energy electrons, and a light detector, which detects the emitted light. FIG. 1(c) schematically shows a cross-sectional structure of the electron detector 1.

Here, a product (e.g., P15 of Kasei Optonix) that emits light even when 1 kV or lower energy electrons are incident is used as a phosphor. The employed material is obtained by doping Zn into a ZnO crystalline base material having a grain size of several micrometers or smaller. The resulting ZnO:Zn powder is applied as a coat while liquid glass or the like is used as a binder, and heated at a temperature between 400° C. and 500° C. over a period of not longer than 1 minute for solidification purposes. Single-crystal ZnO film, which exhibits excellent crystallinity, is not suitable for the intended purpose because it emits weak light upon low energy electron irradiation. Single-crystal or polycrystal, electrically conductive ZnO film that is rich in Zn or other impurities and crystal defects may be used to increase the amount of luminescence. The use of such a ZnO film is advantageous because it accomplishes formation without using liquid glass or other binder material and provides increased mechanical strength.

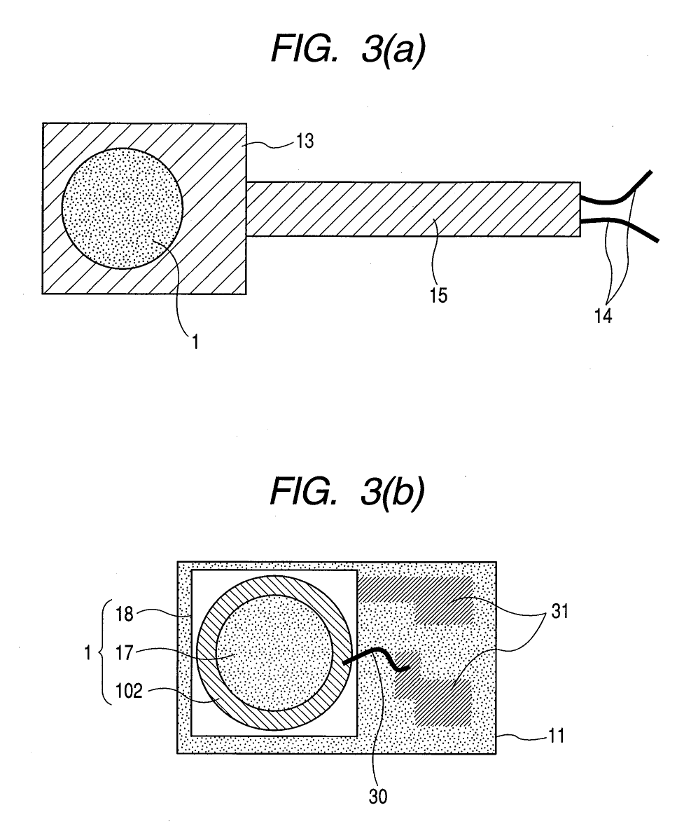

FIG. 3(a) is a schematic diagram of the electron detector 1 shown in FIG. 1(b) as viewed from the sample side. FIG. 3(b) is a schematic diagram of an electron detector main body, which is placed in the case 13. A wiring pattern 31 is formed on the surface of the base plate 11, which is composed of resin or ceramics or other insulation material, by means of plating or bonding. Two types of wiring pattern 31 are formed for the anode and cathode of a photodiode and used to bring the electrodes into electrical contact with the wires 14. When the photodiode is to be fastened to the base plate 11, an electrically conductive adhesive or low melting point metal is used to electrically connect an anode electrode 101 (FIG. 1(c)) to the wiring pattern 31. On the other hand, the connection between a cathode electrode 102 and wiring pattern 31 is made with a gold, aluminum, or other similar bonding wire 30. The wires 14 are connected to the wiring pattern with screws or by soldering or brazing.

When a fluorescence emission material for emitting visible light is used, the depth of submersion in Si is limited. Therefore, a reach-through type APD structure should preferably be used so that the phosphor is coated onto the side toward a light absorption region as shown in FIG. 1(c). In the reach-through type APD structure, an avalanche amplification region and the light absorption region are separated from each other so that the light absorption region is low in impurity concentration and used as an electron drift region for injecting electrons into an avalanche region.

A BSE image can be obtained. Since a WD of 1.5 mm is adequate for functioning, backscattered electrons can be detected even when the acceleration voltage of electrons incident on the sample is extremely low, that is, between 100 V and 800 V. As a result, a high-resolution backscattered electron image can be obtained. Further, when a bias voltage of approximately −300 V to −2000 V is applied to the sample in this instance, the sensitivity increases because the backscattered electrons are accelerated in an electric field between the sample and objective lens.

The operation of the electron detector will now be described.

About half the photons generated from phosphor film are incident on an APD so that electrons and holes are generated in a low impurity concentration region, which is marked i-Si as shown in FIG. 1(c). As for the APD, a positive (+) voltage is applied to the cathode electrode 102 while a negative (−) voltage is applied to the anode electrode 101, that is, the diode is inversely biased. The electrons excited by light are accelerated by the applied bias in a high electric field region of a depletion layer formed between a p-Si layer and an n-Si layer. Subsequently, a process for exciting electron-hole pairs is performed to obtain an avalanche-multiplied current signal.

Since the present embodiment converts low energy electrons to light, the depth of submersion in Si is sufficient. This ensures that photoelectric conversion takes place in a sufficiently thick i-Si layer subsequently to the passage through a p+ layer. Consequently, high quantum efficiency is obtained.

When, for comparison purposes, an SSD is used to measure backscattered electrons at 1 kV, 5 pA or so, the SSD provides a magnification ratio of approximately 30 and an operating band of 100 kHz or lower, and generates about one image per second. The detector according to the present invention, on the other hand, uses a combination of the phosphor and APD to provide a gain of approximately 1000 and a high-speed response band of approximately 1 MHz. Therefore, it generates a maximum of approximately 30 high S/N ratio images per second. Consequently, the present invention makes it possible to obtain high S/N ratio images within a short period of time. Further, the present invention achieves excellent image response so that manual and automatic focusing operations can be easily carried out within a short period of time.

When a sample is observed in a lower acceleration region, that is, when, for instance, approximately 300 V electrons are used for sample observation, 300 eV backscattered electrons can no longer be detected by the SSD. On the other hand, the detector according to the present invention can achieve detection with high sensitivity because a ZnO phosphor functions.

To reduce a probe beam of low energy electrons to a small spot in SEM, it is necessary to minimize the chromatic aberration. Since a chromatic aberration coefficient is substantially equal to the lens focal length f, the key to high resolution is to position the sample close to the objective lens. To achieve high resolution in low acceleration mode with a high-resolution SEM, it is important that the working distance be not longer than 3 mm or, more preferably, not longer than 2 mm. To position a backscattered electron detector between the objective lens and sample under such conditions, it is preferred that the backscattered electron detector be less than 2 mm in thickness. Since the present invention permits the total thickness of a Si substrate and the base plate, which supports the Si substrate, to be less than 1 mm in thickness, it is suitable for providing a low-voltage, high-resolution SEM capable of detecting backscattered electrons.

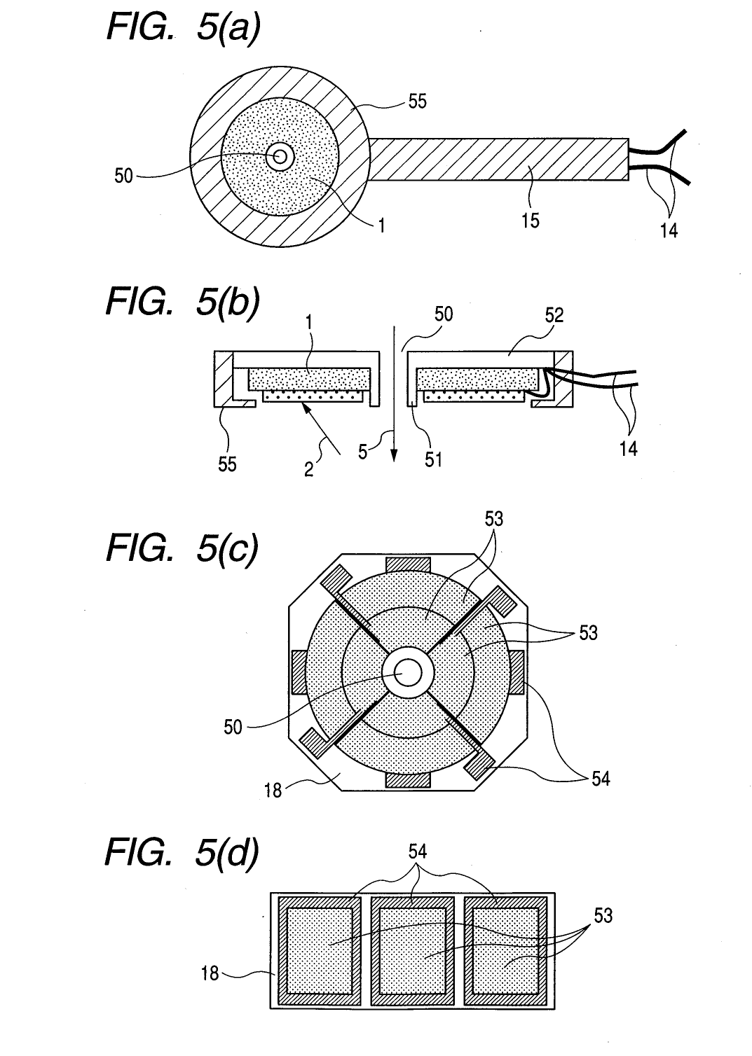

FIGS. 5(a) to 5(d) show some variations of the electron detector according to the present invention. FIGS. 5(a) and 5(b) show a typical structure of an annular type electron detector. FIG. 5(a) is a schematic diagram of the annular type electron detector as viewed from the sample side. FIG. 5(b) is a schematic cross-sectional view of the annular type electron detector. Since this annular type electron detector has a hole (opening) 50 for the passage of a probe electron beam 5, it is suitable for an application where it is positioned below the objective lens and fixed to the axis of an electron beam as indicated, for instance, in FIG. 1(a). For the electron detector shown in FIGS. 5(a) and 5(b), a cylinder electrode 51 is positioned along the central hole 50 in a conductive substrate 52 to form a shielding structure for preventing the detector 1 from interfering with the probe electron beam 5. In this case, the employed detector 1 also has a central hole and is provided with an external cover 55.

FIGS. 5(c) and 5(d) show a partitioned detecting region. The partitioned detecting region is formed by dividing into a plurality of partitions the structure composed of the phosphor layer 17, cathode electrode 102, P⁺-Si region, I-Si region, p-Si region, and n-Si region (in order named as viewed from the sample side) as shown in FIG. 1(c) and covering the other regions with an insulator layer 19. The anode electrode 101 is provided over the entire surface without being partitioned and used as a common anode. FIG. 5(c) shows a typical annular type partitioning method and indicates that the partitioned detecting regions 53 and partitioned detector contact electrodes 54 are formed on the sample side. When the electron detector is installed, the cover 55 shields the partitioned detector contact electrodes 54 to avoid the incidence of an electron beam from the sample side.

The phosphor film may be coated directly onto a semiconductor device or via transparent film. When electrically conductive film such as ITO (In—Sn oxide) film is used as the transparent film, it is suitable for the detection of low energy electrons and large current because it prevents static buildup.

The present embodiment uses ZnO:Zn, which is based on ZnO, as the material for a scintillator that generates light from low energy electrons, particularly, 1 keV or lower energy electrons. However, the use of SnO₂:Eu which is based on SnO₂, a material based on ZnS, or other material also provides the same advantages as far as at least one type of phosphor that efficiently emits light when struck by low energy electrons. Although 1 kV or lower energy electrons are basically targeted, electrons with an energy of up to 2 kV or so may also be used. Further, electrons with an energy as low as 100 eV or lower than 100 eV may be used as well. When ZnO:Zn is used, electrons with an energy of approximately 100 eV can also be detected. However, the sensitivity increases when an electron beam is accelerated. Therefore, a bias of approximately +100 V to +1000 V may be applied to the detector. If a fluorescence emission material for emitting visible light is used, the depth of submersion in Si is limited. Therefore, a reach-through type APD structure should preferably be used so that the phosphor is coated onto the side toward the light absorption region. In the reach-through type APD structure, the avalanche amplification region and light absorption region are separated from each other so that the light absorption region is low in impurity concentration and used as the electron drift region for injecting electrons into the avalanche region.

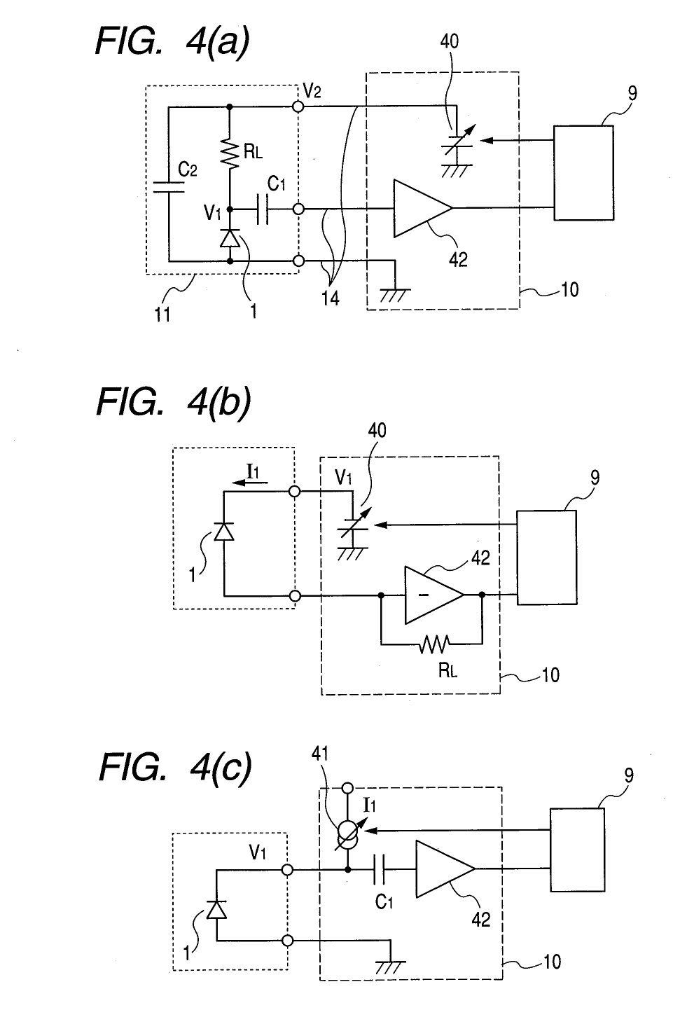

FIGS. 4(a) to 4(c) show typical detecting circuits 10 for use in the electron detector according to the present invention. The detecting circuit 10 shown in FIG. 4(a) uses a variable bias voltage source 40 to apply a voltage of V₂, causes a resistor R_{L}, which is connected in series with the detector 1, to convert a detected current to a voltage signal, uses a capacitor C₁ to enter only an alternating current portion to an amplifier 42 of the detecting circuit 10, allows a signal voltage to be amplified to an appropriate value, and forwards the amplified signal voltage to the controller 9. In this instance, the detection sensitivity is determined by the bias voltage V₁ of the detector 1. Therefore, the controller 9 sets the voltage V₂ of the variable bias voltage source 40 so as to obtain an appropriate value. A capacitor C₂ is added to decrease the supply impedance for the purpose of preventing the signal response from being lowered by wiring resistance.

The detecting circuit 10 shown in FIG. 4(b) is composed of a smaller number of parts. When this configuration is employed, the output of the variable bias voltage source 40 is the bias V₁ of the detector, and a circuit for converting the signal current to a voltage is formed in the detecting circuit 10. In this configuration, the sensitivity of the detector is determined solely by the voltage of the voltage source 40. Since this configuration makes it possible to set the sensitivity accurately without regard to the detected current, it is suitable for measurements where high accuracy is required. Further, the resistor R_{L}, which is provided for the amplifier 42, can change a current-voltage conversion coefficient. Therefore, a relay, a selector, or the like may be used to select an appropriate value from among a plurality of predefined R_{L} values. In this instance, the optimum conditions for S/N ratio can be set in various modes ranging from a high-sensitivity slow-scanning mode to a low-sensitivity fast-scanning mode.

The detecting circuit 10 shown in FIG. 4(c) uses a variable bias current source 41 to drive the detector 1 with a constant current, and causes the amplifier 42 to detect a V₁ change in the detector via the capacitor C₁. When the number of electrons entering the detector decreases, the bias voltage V₁ increases. When, on the other hand, the number of electrons entering the detector increases, the bias voltage V₁ decreases. Thus, there is a reversal relationship between the electron signal and output voltage intensity. Here, the V₁ value varies with the number of input electrons. More specifically, the sensitivity is high when there are a small number of electrons and low when there are a large number of electrons. Consequently, there is an advantage in that detection can be achieved over an extremely wide dynamic range no matter whether the number of electrons is extremely small or large.

### Second Embodiment

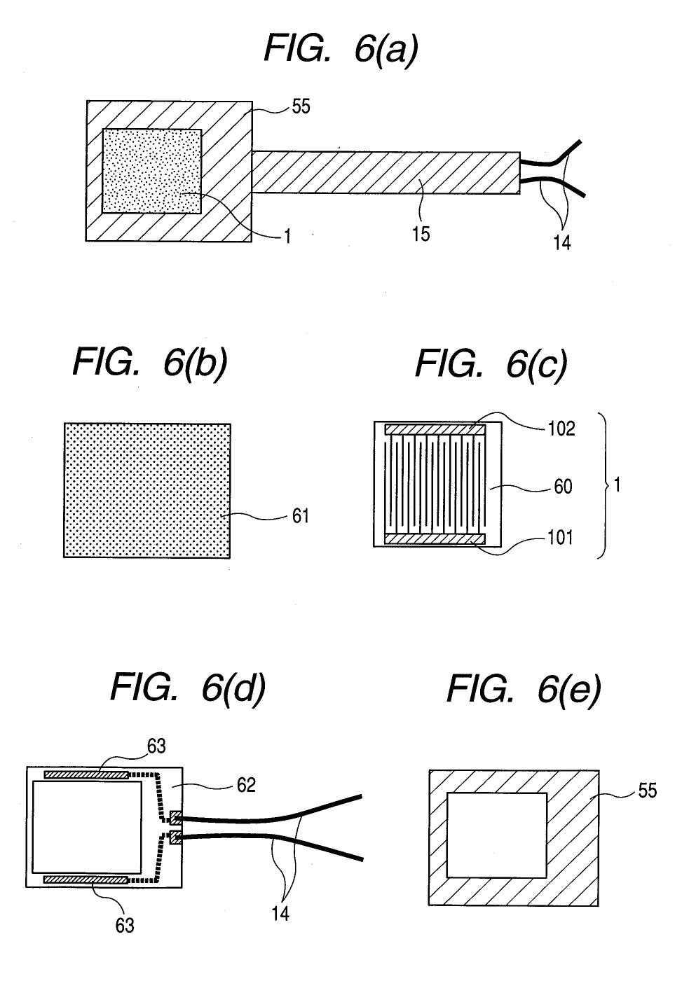

FIGS. 6(a) to 6(e) show the electron detector according to a second embodiment of the present invention, which is configured by using a substrate having a large energy gap.

The second embodiment will be described on the assumption that a diamond substrate is used as the substrate having a large energy gap. In the present embodiment, comb-like electrodes 101, 102 are mounted on a surface of the diamond substrate and positioned face to face. When electrons are injected while a potential difference of 10 to 100 V is applied across the electrodes, the incident electrodes generate electron-hole pairs. The electrons travel toward the positive (+) electrode, whereas the holes travel toward the negative (−) electrode.

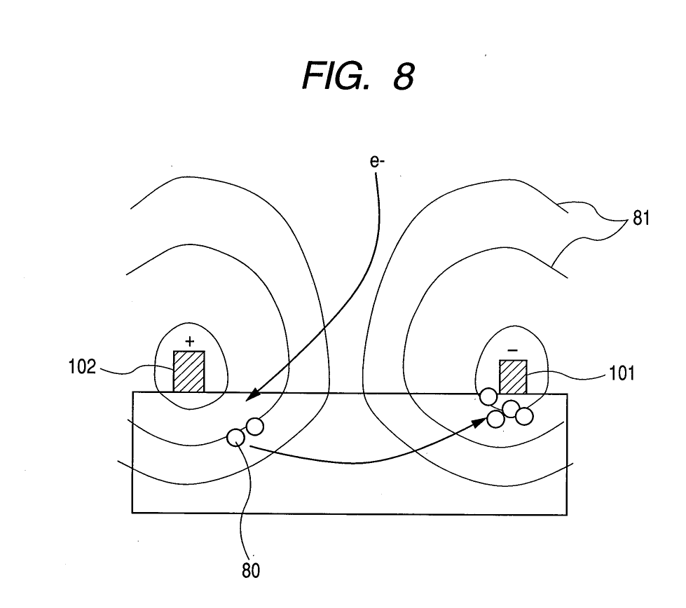

Since the hole ionization rate is high within diamond, avalanche multiplication is solely determined by the holes traveling in a high electric field. FIG. 8 is a schematic structural cross-sectional view of avalanche multiplication. When an electron beam is to be measured, the present embodiment is advantageous, for instance, in that an electron beam (e⁻) traveling in a vacuum can be attracted closer to the plus (+) side of the electrode 102. As resulting holes 80 can then travel toward the minus (−) side of the electrode 101, the efficiency of avalanche multiplication can be enhanced to achieve a high S/N ratio. The maximum image magnification obtained in this instance is 1 million. This makes it possible to accomplish detection with extremely high sensitivity. As diamond is mechanically robust, even the use of a thin cover provides a sufficiently stiff structure. Therefore, diamond is used as a sensor having a thickness of 1 mm or less. The reference numeral 81 in the figure denotes an equipotential line.

FIGS. 6(a) to 6(e) illustrate the structure and typical fabrication method according to the present embodiment. Fabrication is achieved by placing the detector 1 (FIG. 6(c)), which is composed of a diamond avalanche diode (DAD)60, on a substrate 61 (FIG. 6(b)), which is made of a thin stainless steel plate, installing a contact frame 62 (FIG. 6(d)) over the detector 1, installing the cover 55 (FIG. 6(e)) over the contact frame 62, and fastening the resulting assembly to the substrate 61. The substrate 61 may be made of either an insulator or metal. In the present embodiment, however, it is close to an electron beam path. Therefore, it should be made of an electrically conductive, nonmagnetic material that does not charge up. FIG. 6(a) is an overall view of the assembled detector.

The contact frame 62 is made of an insulator and provided with a central square hole through which electrons pass. Its upper and lower edges are provided with contact electrodes 63 so that the anode electrode 101 and cathode electrode 102 of the detector 1 come into electrical contact with each other upon completion of assembly. The wires 14 are connected respectively to the contact electrodes 63 to wire the contact electrodes 63 to an external detecting circuit. A spring can be placed between the contact frame 62 and cover 55 or between the detector 1 and substrate 61 to assure contact between the contact electrodes 63 and the cathode and anode electrodes 102, 101. Alternatively, the substrate 61 may be made of an elastic, thin, metal plate and secured to retain contact pressure after completion of assembly.

For the sake of convenience, the figure indicates that a positive voltage is relatively applied to the cathode with a negative voltage relatively applied to the anode, as is the case with a p-n junction rectifier diode, when avalanche amplification is to be performed. However, two Schottky junctions are substantially created by providing a wide bandgap semiconductor with two metal electrodes. Therefore, the resulting device is equivalent to what is obtained by connecting a Schottky diode in a reverse direction. No substantial difference arises no matter which electrode is positive and which is negative. Since a voltage oriented in the direction opposite to the direction of conduction is applied to a p-n junction diode, a positive voltage is relatively applied to the cathode whereas a negative voltage is relatively applied to the anode.

When six orders of magnitude of gain is obtained, the attained sensitivity is equivalent to that is provided by a combination of a photomultiplier and an E-T scintillator, that is, a scintillator to which a bias of approximately 10 kV is applied. Therefore, the device can also be used as a secondary electron detector. In this case, there is an advantage in that the device can be fabricated to be far smaller in size than the E-T type and installed at various sites.

Further, since diamond is used as an electron detector, normal visible ultraviolet light cannot be sensed. Therefore, this detector is beneficial when used for electron detection in an environment that cannot be lighttight. For example, this detector makes it possible to simultaneously observe light and electrons when an optical microscope is combined with an electron microscope. More specifically, this detector can implement, for example, a device that can simultaneously perform recording and SEM observation operations in a recording apparatus in which a phase change is invoked by light. In addition, this detector makes it possible to conduct high-magnification observations based on electrons while observing a large region or colors with an optical microscope.

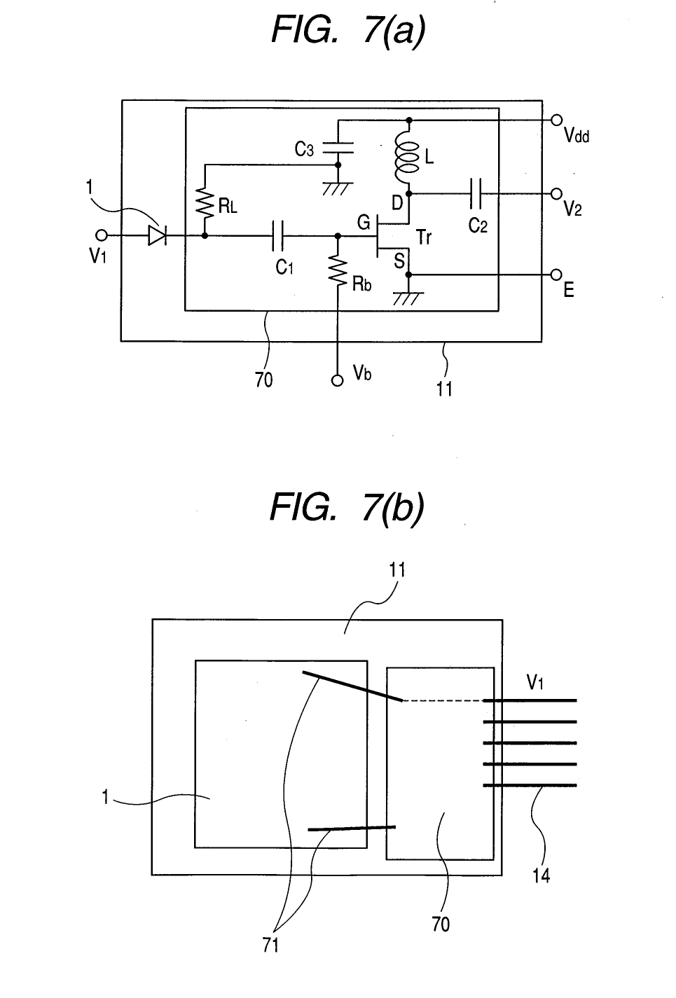

When detection is to be accomplished at an increased speed, an amplifier should be positioned near a diode amplifier. When, for instance, a signal is transmitted after being amplified by a high-speed, low-NF transistor Tr as shown in FIGS. 7(a) and 7(b), detection can be accomplished at frequencies of 1 MHz and higher and up to a frequency close to 1 GHz. Here, a high-electron-mobility transistor (HEMT) Tr is used to apply a gate (G) bias voltage Vb of approximately −0.5 V via a resistor Rb. Further, the voltage V₁ is applied to determine a diode avalanche multiplication factor and operating conditions. The signal portion of a flowing current is directed to the gate of the transistor Tr by a load resistor R_{L} and a coupling capacitor C₁. In this instance, the values R_{L} and C₁ are optimized for signal source impedance. The value Rb is set to be a great value in the megohm order so that it does not interfere with the values R_{L} and C₁. A signal is output to an output terminal V₂ through a coupling capacitor C₂. In this instance, a coil L is inserted into a power supply Vdd for transistor operations in order to isolate high-frequency components. A circuit substrate on which the above circuit is mounted on a frame and positioned close to the detector 1 with wiring connections external wiring is extended over a certain distance, the high-speed characteristic remains unimpaired. Therefore, the operation can be performed over a wide band of frequencies up to approximately 1 GHz. Thus, the device is useful when applied to a high-speed inspection apparatus. Although it is assumed here that only one detector 1 is used, a plurality of detectors may alternatively be combined. When such an alternative configuration is employed, the amplifier circuit should be provided for each detector. Another alternative would be to add a switch for changing the wiring between the detector 1 and circuit.

The present embodiment uses diamond as the medium for the avalanche multiplication wide gap. However, the use of a different material will also provide the same advantages. When, for instance, a ZnO single crystal is used, p-type and n-type doping can be accomplished more easily than when diamond is used. Therefore, the intended purpose is achieved by the use of a thin-film multilayer PIN structure without employing the comb-like structure shown in FIG. 6(c). The use of a thin-film multilayer PIN structure dose not only facilitates electrode fabrication but also minimizes the region insensitive to electron irradiation. This provides enhanced electron collection efficiency and produces images with a high S/N ratio. Further, there is an advantage in that the materials can be obtained at a low cost. In addition, a p-type or n-type ZnO layer can be replaced with a thin metal film in the above case. The reason is that the use of a wide-gap material makes it possible to maintain a low dark current between a metal and Schottky junction. FIG. 7(b) shows the positional relationship between the detector 1, preamplifier 70, and wiring 14, which are amounted on the base plate 11.

When diamond is used to create a surface condition suitable for the detection of low energy electrons, it is preferred that the employed structure be terminated with hydrogen atoms. The use of such a structure makes it possible to adjust the band structure close to the surface so that electrons and holes are properly introduced into each electrode even when low energy electrons having a small submersion depth are incident. When the energy of incident electrons is between several kilovolts and 10 kV or higher, the penetration depth is increased. Therefore, although hydrogen termination is preferred, the device operates as a sensor without requiring any special processing.

### Third Embodiment

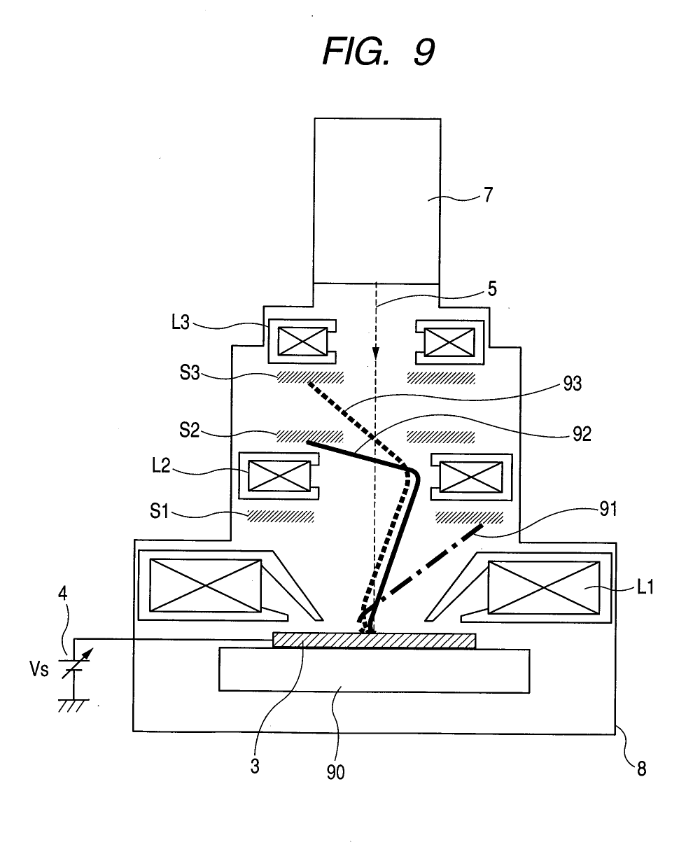

FIG. 9 is a conceptual diagram illustrating a typical electron beam apparatus that makes use of compactness and high sensitivity of the detector according to the present invention. FIG. 9 shows a scanning electron microscope (SEM) as an example of the electron beam apparatus. Probe electrons 5 generated from the electron beam irradiation source 7 are adjusted so that three electron lenses (L1, L2, and L3 in FIG. 9) form a very small focus spot on the surface of the sample 3. The deflector then sweeps the focus spot in x and y directions. Electrons generated from the sample are converted to an electrical signal by the detector so as to observe a microscopic region of the sample surface. Although the deflector is not shown in the figure, it is positioned between lenses L1 and L2. A substrate bias voltage source 4 applies a voltage Vs to the sample 3. The employed structure is configured to decelerate the probe electrons 5 immediately before the sample 3 so that high-resolution observations can be made even when the incident energy is small.

Three detectors (S1, S2, and S3) are placed at their respective positions. These detectors are obtained by combining a phosphor with an avalanche photodiode as indicated in FIGS. 5(a), 5(b), and 5(c), and provided with a central hole.

The electrons generated from the sample 3 include secondary electrons 92, which are radiated from the sample with an energy not higher than approximately 5 eV, and backscattered electrons, which are emitted while they retain a certain energy without significantly losing the energy of incident electrons. The backscattered electrons can be classified into high angle backscattered electrons 93, which are within an angle of approximately 30 degrees from the normal line of a sample substrate, and low angle backscattered electrons 91, which are distributed between an angle greater than 30 degrees from the normal line and an angle of substantially zero degrees from the sample surface. Representative orbits of the above three types of electrons are shown in FIG. 9. The secondary electrons 92 and high angle backscattered electrons 93 move upward near the central axis due to the voltage Vs applied to the sample and a magnetic field generated by lens L1. On the other hand, the low angle backscattered electrons 91 are mainly detected by detector S1 because they have a considerable lateral kinetic energy and spread below lens L2. Electrons passing upward through lens L2 focus above lens L2 because they obtain a convergent orbit due to the lens action of lens L2. However, the secondary electrons, which have a low energy and differ in kinetic energy, focus at a nearer position and then obtain a divergent orbit. Therefore, the secondary electrons are mainly detected by detector S2. The high angle backscattered electrons 93, which have a high energy, focus at a farther position. Therefore, the high angle backscattered electrons 93 pass through the hole in detector S2 and are mainly detected by detector S3, which is positioned at a higher position. The secondary electrons 92 provide surface irregularity information, whereas the backscattered electrons provide surface shape information, internal composition information, and crystal information. The high angle backscattered electrons 93 mainly provide composition information and crystal information, whereas the low angle backscattered electrons 91 provide composition information, crystal information, and surface irregularity information. Consequently, the present embodiment is characterized in that the surface irregularity information, composition information, and crystal information about the sample can be discriminatingly derived from the three detectors.

Applying the present invention to the detectors provides an advantage in that the resultant detectors are more compact than, for instance, E-T detectors and MCP detectors. In this instance, the distance between detectors S3 and S1 can be 30 cm or shorter. Further, since the voltage to be applied is not higher than approximately 100 V, which is an operating voltage for an avalanche photodiode, another advantage is provided in that inexpensive wires and insulators can be used.

When detectors S1 and S3 are of a partitioned type, which has a plurality of partitioned detecting regions 53 (three partitioned detecting regions in the present embodiment) as shown in FIG. 5(c), detection can be achieved on an individual azimuth direction basis during electron emission. This makes it possible, for instance, to form a stereographic image, which is obtained when an object is viewed from right- and left-hand sides, or a three-dimensional image, and make three-dimensional observations of a sample surface. Under normal conditions, generated electrons rotate in a magnetic field inside lens L1 and the angle of rotation varies with energy. After passage through lens L1, therefore, it is difficult to predict the azimuth angle prevailing during initial emission. However, the present embodiment is structured so as to differentiate between backscattered electrons and secondary electrons as mentioned earlier. It means that it is possible to select an energy range of electrons to be detected. Particularly, high energy backscattered electrons can be selected while the variation of the angle of rotation in lens L1 is reduced. Therefore, the partitioning of the detectors S1 and S3 is effective. Further, classification can also be achieved on an individual emission angle basis in a situation where radial partitioning is done. Consequently, it is possible, for instance, to obtain depth distribution information as well as crystal orientation information, which is based, for instance, on the difference in the contrast of crystal-induced scattering.

Here, the combination of a phosphor and an avalanche photodiode is used as detectors S1, S2, and S3. However, the same advantages can be obtained as far as the central axis has a space through which the probe electrons 5 pass. Therefore, the same advantages are gained even when the employed detectors are without a hole as shown in FIGS. 3(a) and 3(b) or made of a wide energy gap material such as a diamond avalanche diode 60. In such a case, it is possible to mount electrodes on a doughnut-shaped diamond substrate with a central hole or use a plurality of small avalanche diodes. When, for instance, the partitioned detecting regions 53 of the detector shown in FIG. 5(c) are to be provided with a DAD 60, it is possible to furnish each partitioned detecting region 53 with two partitioned detector contact electrodes 54 or allow the other partitioned detecting regions 53 to share either the anode electrode 101 or cathode electrode 102 because the anode electrode 101 and cathode electrode 102 are mounted on the surface.

Similarly, it goes without saying that a DAD 60 can also be applied to a partitioned type shown in FIG. 5(d).

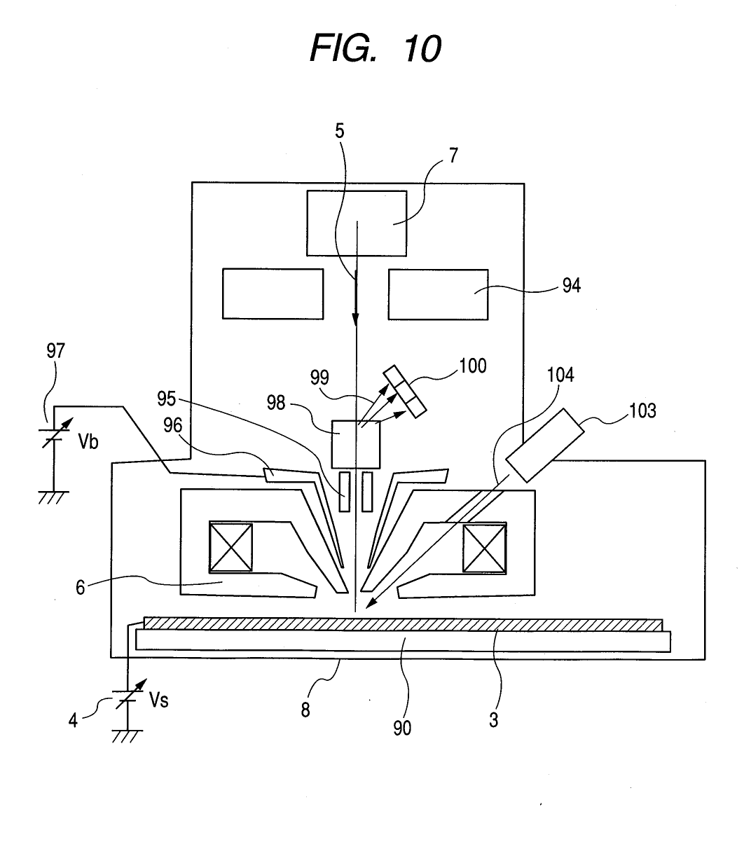

FIG. 10 is a conceptual diagram illustrating another modification. This diagram shows an SEM suitable for semiconductor substrate measurements. It has an optical measuring device 103 near the objective lens 6 and radiates probe light 104 onto an electron-beam-based observation region on the sample 3. Further, the energy of an electron beam 5 incidents on the sample 3 is not higher than 2 kV while a low acceleration voltage of approximately 100 V is used. Therefore, the employed configuration reduces the chromatic aberration and other resolution decrease factors by causing the substrate bias voltage source 4, booster tube 96, and booster voltage source 97 to increase the kinetic energy of the probe electron beam 5 traveling in the objective lens 6 and by providing deceleration to a desired energy immediately before the sample 3.

Electrons generated from the sample become accelerated by a deceleration electric field for the probe electron beam 5, travel upward, and enter an ExB deflector 98 above a deflector 95. The ExB deflector 98 is placed in a state called the Wien condition so as to generate a magnetic field in a direction perpendicular to the paper surface, generate an electric field in a horizontal direction and perpendicularly to the central axis of the probe electron beam 5, and allow the magnetic field's influence on the probe electron beam 5 to counteract the electric field's influence on the probe electron beam 5. When the electrons generated from the sample are incident on the lower surface of the ExB deflector 98, they are deflected in one direction. In addition, since the deflection angle varies with energy, the deflected electrons 99 from sample variously spread in accordance with the energy. A partitioned multi-detector 100, which is a detector according to the present invention and has a plurality of independent detection areas at different locations as shown in FIG. 5(d), can be positioned ahead of the ExB deflector 98 to detect the intensities of the deflected electrons 99 from sample in accordance with their spread positions. Since the kinetic energies of signals from the detection areas of the partitioned multi-detector 100 are determined from ExB deflection intensity, it is possible to determine the energy distribution of the deflected electrons from sample. Here, the ExB deflector 98 can change the intensities of the electric field and magnetic field while maintaining the Wien condition. Therefore, electrons in a desired energy region can be detected by changing the electric field and magnetic field in accordance with energy requirements.

The surface charge potential can be determined by using the partitioned multi-detector 100 as described above, or more specifically, by locating the energy peak position of secondary electrons on the low energy side. Further, there is an advantage in that only the distribution of a particular material can be rapidly extracted by selecting electrons having a characteristic energy that are generated from the particular material. Furthermore, only the composition information and crystal information can be extracted by selecting only the high energy backscattered electrons to discard the surface irregularity information. Alternatively, the crystal information and material information about the interior of the sample 3 can be obtained by extracting the low energy backscattered electrons.

The optical measuring device 103 is used to measure the height of the sample, observe a low-magnification optical microscope image of an observation region, and change the surface charge condition by irradiating the sample with near-ultraviolet light or visible light. Further, the optical measuring device 103 is used as a simple circuit tester by irradiating a semiconductor circuit with light, causing a potential change, for instance, in a p-n junction or Schottky junction, and detecting the potential change through the use of an electron beam. When a diamond detector 60 or other detector that has a wide energy gap and does not detect visible light and near-ultraviolet light is used to configure the partitioned multi-detector 100, it is effectively used as a high-speed inspection device or a circuit tester because it can achieve electron beam detection with high sensitivity simultaneously with probe light radiation.

### Fourth Embodiment

Electron detectors made of diamond or other material having a wide bandgap do not achieve detection even when they are irradiated with light having a lower energy than the bandgap energy. Therefore, they permit light irradiation even while an image is being observed with secondary electrons or backscattered electrons by scanning an electron beam or ion beam.

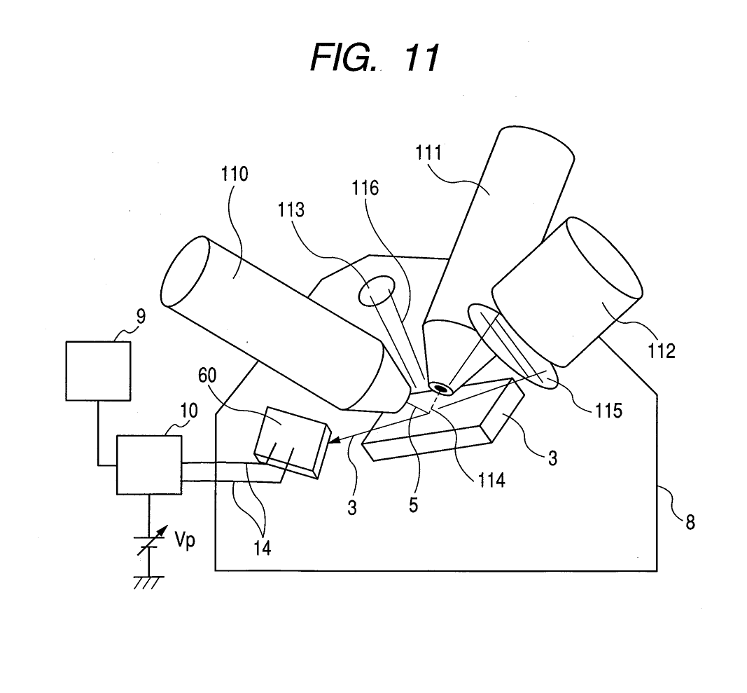

FIG. 11 shows an embodiment in which an apparatus for processing a sample with an ion beam is used so that a microscopic processed portion is observed with an SEM placed in the same vacuum device while at the same time a wider visual field is observed with an optical microscope. The figure mainly depicts a sample observation chamber. A vacuum chamber 8 includes an ion beam column 111, which generates a converged ion beam 114 to process a portion near the surface of the sample 3; an electron beam column 110, which radiates a thin probe beam 5 of electrons for observing the condition of a microscopically processed region; a diamond detector 60, which mainly detects electrons generated from the sample 3; and an illumination light source 113 and an optical microscope window 115, which are used for observing the sample surface with an optical beam. An optical microscope 112 is positioned outside the optical microscope window 115.

The configuration shown in FIG. 11 reduces the processing time because it makes it possible to locate a necessary cutout portion of a wafer with the optical microscope, move a stage immediately, cut out the necessary portion, and make an SEM observation. Therefore, an increased number of sample observations can be carried out within a predetermined period of time. The objective lens of the optical microscope may be placed in a vacuum. In such an instance, the lens is positioned close to the sample so that an optical microscope image can be observed with high resolution. The same advantages are obtained even when light is radiated, for instance, through the window or optical fiber with the illumination light source 113 placed outside the vacuum.

Various items of information, which are obtained when the overall potential of the diamond detector 60 is varied, can be differentiated from each other. The structure shown in FIG. 11 applies a post voltage Vp to the detecting circuit 10 and operates the detector at a potential of Vp. When the post voltage Vp is a high positive voltage between +1 kV and +10 kV, low energy secondary electrons are aggressively taken into the detector to increase the detection efficiency. Such an increase in the detection efficiency is effective for observing a secondary electron image during ion beam irradiation or electron beam irradiation. When, on the other hand, the post voltage Vp is a high negative voltage between −1 kV and −10 kV, electron beam detection does not take place, but the detection efficiency for positively charged particles increases. Such an increase in the detection efficiency is effective for observing an ion beam reflected from the sample.

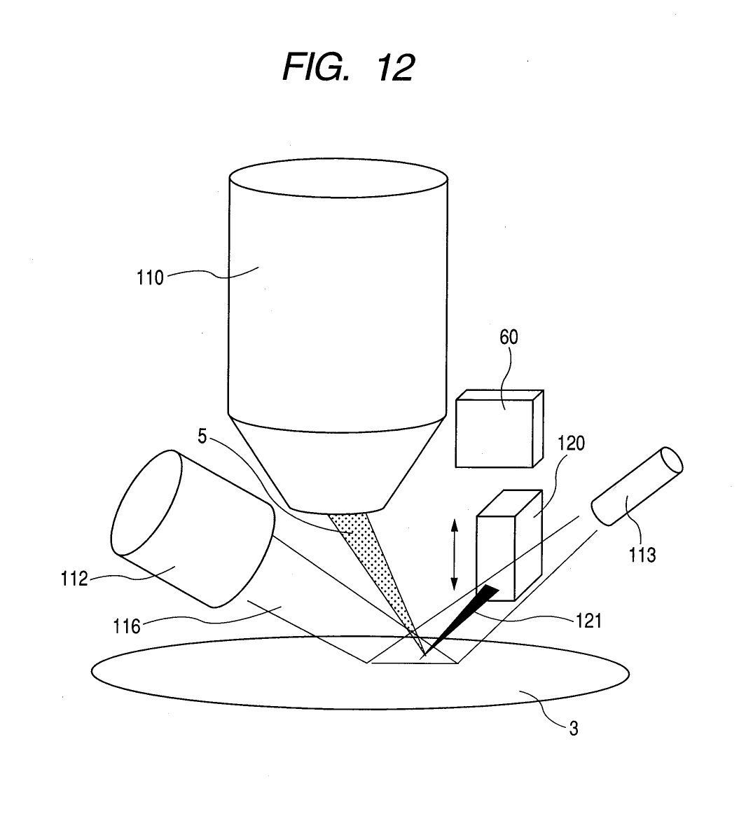

FIG. 12 relates to another application where an inspection apparatus causes a probe needle 121 to locally come into electrical contact with the surface of the sample 3 and uses an external electrical tester to examine the electrical characteristics of the sample. This figure is a schematic diagram illustrating a portion of the inspection apparatus that is placed in a vacuum. If necessary, a plurality of probe needles 121 are used. The optical microscope 112 is used to observe the approximate position of the probe needle. A probe needle actuator 120 is used to determine the horizontal position of the probe needle 121. Finally, the height of the probe needle 121 is controlled to bring it into contact with the sample. When a region with which the probe needle 121 comes into contact cannot readily be observed with the optical microscope 112, that is, when its size is between several microns and several nanometers, an electron beam 5 is used to observe such a region. Since the diamond detector 60 is used for electron beam observation, the optical microscope and scanning electron microscope can be simultaneously used for making observations. Thus, the time required for the movement of the probe needle 121 can be shortened to make prompt observations. When the p-n junction of a semiconductor or other target whose characteristics vary with light is to be observed, the incidence of light is shut off.

Here, the optical microscope is used as an example where light is introduced while at the same time an electron beam is used for observations. However, the use of light for modulating a semiconductor surface potential, light for controlling surface charge, or light for preventing the surface from being charged or soiled does not affect the detection of electrons either. As is obvious from the foregoing description, therefore, the advantages of respective light introduction are evident.

The electron detector according to the present embodiment uses diamond as a wide bandgap material and does not detect visible light and near-ultraviolet light. However, a bandgap energy sufficiently higher than the energy of employed light, that is, an energy of +0.1 eV or higher, may be selected so as not to detect the employed light. Further, if the band structure is of an indirect transition type, the bandgap energy is not directly related to light absorption. In such a situation, the selection should be made so that the minimum energy absorbed by the light absorption end of the material, that is, the minimum energy absorbed by a semiconductor, is higher than the energy of the employed light by at least 0.1 eV. When, for instance, light within the visible region is used, a wide-gap semiconductor substrate having a bandgap greater than 2 eV as an electron absorption region should be selected as an actual material. More specifically, a material based, for instance, on a GaN, GaP, or ZnO single crystal may be selected. The selection of such a material is advantageous in that the material cost is low. GaP has a bandgap of 2.26 eV and has an absorption end at 549 nm. Therefore, when GaP is used, red light or near-infrared light, which has a longer wavelength than the absorption end, should be used. GaN makes it possible to virtually use the entire visible light region because it has a bandgap of 3.36 eV and has an absorption end at 336 nm. ZnO can be used in the same manner because it is transparent within the entire visible light region.

When diamond is used, the reverse connection of a Schottky junction is used because there are no appropriate impurities that form a good ohmic junction for the p-type or n-type. However, if there are appropriate impurities, that is, if at least an ohmic contact can be formed for a p- or n-type region, no extra potential is required for the junction. This provides an advantage in that the use of a low application voltage is permitted. The use of a diamond detector creates a dead region where electrons incident on the two comb-like electrodes and its vicinity are not detected. However, when the employed material forms an ohmic contact under impurity control, the p-n junction can be formed in the direction of film thickness as far as the base of film is provided with an impurity region for either of the two types. Since this makes it possible to detect the entire front surface as is the case with the use of a Si avalanche photodiode, a highly efficient detector is obtained.

As described in conjunction with various embodiments of the present invention, the use of the present invention makes it possible to obtain a charged particle beam application apparatus having a highly sensitive, compact electron beam detector. Therefore, the present invention can provide a charged particle beam measuring/processing apparatus that is capable of making measurements simultaneously with a small-size, high-resolution SEM, an SEM capable of differentiating pieces of information from each other in accordance with energy, a length measuring SEM, an ion-beam-based microscope, or an optical probe.

What is claimed is:

1. A charged particle beam application apparatus comprising:
a charged particle source;
a charged particle optics for irradiating a sample with a charged particle beam emitted from the charged particle source; and
electron detection means for detecting electrons that are secondarily generated from the sample;
wherein the electron detection means includes a diode device that is a combination of a phosphor layer, which converts the electrons secondarily generated from the sample to an optical signal, and a device for converting the optical signal to electrons and subjecting the electrons to avalanche multiplication;
wherein the phosphor layer uses ZnO, SnO₂, or ZnS as a base material and is mainly made of at least one type of phosphor that emits light when struck by 1 keV or lower energy electrons; and
wherein the device for converting the optical signal to electrons and subjecting the electrons to avalanche multiplication is mainly composed of Si.

2. A charged particle beam application apparatus comprising:
a charged particle source;
a charged particle optics for irradiating a sample with a charged particle beam emitted from the charged particle source; and
electron detection means for detecting electrons that are secondarily generated from the sample;
wherein the electron detection means includes a diode device having an electron absorption region that is composed of at least a wide-gap semiconductor substrate with a bandgap greater than 2 eV; and
wherein the electron absorption region is configured so that two electrodes are mounted on the substrate and positioned face to face to generate electron-hole pairs upon incidence of electrons secondarily generated from the sample.

3. The charged particle beam application apparatus according to claim 1, wherein the phosphor is mainly made of a ZnO:Zn phosphor material or a SnO₂:Eu phosphor material.

4. The charged particle beam application apparatus according to claim 2, wherein the wide-gap semiconductor substrate is made of a GaP, GaN, ZnO, or C single-crystal semiconductor.

5. The charged particle beam application apparatus according to claim 1, further comprising:
a detecting circuit which is positioned near the electron detection means or an electron beam application apparatus to apply a current or voltage for operating the electron detection means and amplify or transmit an electrical signal from the electron detection means.

6. The charged particle beam application apparatus according to claim 1, wherein the electron detection means is positioned near a path for an electron beam incident on the sample.

7. The charged particle beam application apparatus according to claim 1, wherein the electron detection means has an opening for the passage of the electron beam and is positioned in a path for the electron beam.

8. The charged particle beam application apparatus according to claim 1, wherein the electron detection means has a plurality of detection areas and means for directing electrons generated from the sample to the plurality of detection areas in accordance with energy.

9. The charged particle beam application apparatus according to claim 4, further comprising:
means for irradiating the sample with light,
wherein the irradiation light has a longer wavelength than the absorption edge of the wide-gap semiconductor substrate for the electron detection means.

10. The charged particle beam application apparatus according to claim 9, further comprising:
an ion beam column for converging an ion beam emitted from an ion source onto the sample for processing purposes,
wherein an electron optics and the ion beam column are positioned in the same vacuum chamber.

11. The charged particle beam application apparatus according to claim 2, further comprising:
a detecting circuit which is positioned near the electron detection means or the electron beam application apparatus to apply a current or voltage for operating the electron detection means and amplify or transmit an electrical signal from the electron detection means.

12. The charged particle beam application apparatus according to claim 2, wherein the electron detection means is positioned near a path for an electron beam incident on the sample.

13. The charged particle beam application apparatus according to claim 2, wherein the electron detection means has an opening for the passage of the electron beam and is positioned in a path for the electron beam.

14. The charged particle beam application apparatus according to claim 2, wherein the electron detection means has a plurality of detection areas and means for directing electrons generated from the sample to the plurality of detection areas in accordance with energy.
